(19) United States
(12) Patent Application Publication
(10) Pub. No.: US 2006/0020672 A1
(43) Pub. Date: Jan. 26, 2006

(54) System and Method to Categorize Electronic Messages by Graphical Analysis

(75) Inventors: Marvin Shannon, Pasaena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/161,121

(22) Filed: Jul. 23, 2005

Related U.S. Application Data
(60) Provisional application No. 60/521,942, filed on Jul. 23, 2004.

(51) Int. Cl. G06F 15/16

(52) U.S. Cl. 709/206

(57) ABSTRACT

We describe a method of computing language-independent metrics (which we term “HideMe” and “HideAll”) to associate with selectable domains in electronic messages. We apply these as indicators as to whether a sender address is false, using a graph which we call a Cloaking Diagram. The metrics and the graph can be used to autoclassify domains involved in the transmission of bulk messages, according to the extent that the domains appear to be forging sender addresses and the extent that the domains appear to be acting as distributors of messages pointing to other domains. Also, we present a method of using a graphical analysis of metadata found from one set of electronic messages, or from two such sets, that reveals groupings or correlations between metadata. These groupings can be used to assign an entire group to a same category. It permits for an efficient determination of spam domains. It attacks the economics of spammers making and selling mailing lists to other spammers. We also can search for open relays that are sending us spam. The method can be used in a manual or algorithmic fashion.

### TECHNICAL FIELD

This invention relates generally to information delivery and management in a computer network. More particularly, the invention relates to techniques for automatically classifying electronic communications as bulk versus non-bulk and categorizing the same.

### BACKGROUND OF THE INVENTION

In email, a persistent problem has been spam (unsolicited bulk messages). Often, such messages have hyperlinks to websites where the spammer is selling some good or service. Spam also often has a fake sender (the From line). This attempts to conceal the origin of the spammer, and to avoid a simple usage of a blacklist that checks only the sender's email address or its domain. Such an ability was an unforeseen consequence of the development of the Internet. In its early, pre-Web days, there was no significant commercial usage (and no HTML) and hence no incentive for any user to forge her address.

Various methods have been suggested recently to authenticate the sender address. Being able to do this would (presumably) help alleviate the spam problem. Notably, these methods include Sender Permitted From and Domain Keys. The former promoted by Microsoft Corporation. The latter promoted by Yahoo Corporation. Unfortunately, both methods require that all (or most) Network Service Providers and Internet Service Providers implement them. As well as organizations running mail servers. And that the NSPs and ISPs not knowingly let spammers operate from within their purview. But there is economic incentive for some NSPs or ISPs to host spammers. Plus, it is very difficult to expect a majority of the Internet to convert over to a new standard. This is exacerbated by the fact that there are these two competing standards. (There may also be others.)

There is a need for a simple way to detect possible fake senders. That does not depend on a widespread uptake across the Internet. Ideally, a single ISP could use it, independent of any other ISP. The present invention addresses this need.

Also, given the presence of domains in selectable links in messages, it would be useful to have some means of classifying or categorizing some (or most) of these domains, as being affiliated with spammers.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We describe various methods of using graphical analysis to attack spam.

We describe a method of computing language-independent metrics (which we term “HideMe” and “HideAll”) to associate with selectable domains in electronic messages. We apply these as indicators as to whether a sender address is false, using a graph which we call a Cloaking Diagram. The metrics and the graph can be used to autoclassify domains involved in the transmission of bulk messages, according to the extent that the domains appear to be forging sender addresses and the extent that the domains appear to be acting as distributors of messages pointing to other domains.

Also, we present a method of using a graphical analysis of metadata found from one set of electronic messages, or from two such sets, that reveals groupings or correlations between metadata. These groupings can be used to assign an entire group to a same category. It permits for an efficient determination of spam domains. It attacks the economics of spammers making and selling mailing lists to other spammers. We also can search for open relays that are sending us spam. The method can be used in a manual or algorithmic fashion.

### BRIEF DESCRIPTION OF THE DRAWINGS

FIG. 1

A table of Bulk Message Envelopes (BMEs)

FIG. 2

A Cloaking Diagram of HideAll versus HideMe.

FIG. 3

A Cloaking Diagram of Diff versus HideMe.

FIG. 4

Table of BMEs around (1,1) in FIG. 2.

FIG. 5

Table of BMEs around (1,0) in FIG. 2.

FIG. 6

Table of BMEs around (0,0) in FIG. 2.

FIG. 7

Domains from Single BMEs versus domains from Multiple BMEs.

FIG. 8

Data from FIG. 7, with clustering along the x axis.

FIG. 9

Data from FIG. 7, with clustering along both axes.

FIG. 10

Hashes from Single BMEs versus hashes from Multiple BMEs.

FIG. 11

Relays from Single BMEs versus relays from Multiple BMEs.

For a more complete understanding of the present invention and the advantages thereof, reference should be made to the following Detailed Description taken in connection with the accompanying drawings.

### DETAILED DESCRIPTION OF THE PREFERRED EMBODIMENT

What we claim as new and desire to secure by letters patent is set forth in the following claims.

In earlier Provisional Patents (No. 60/320,046, “System and Method for the Classification of Electronic Communications”, filed Mar. 24, 2003; No. 60/481,745, “System and Method for the Algorithmic Categorization and Grouping of Electronic Communications”, filed Dec. 5, 2003; No. 60/481,789, “System and Method for the Algorithmic Disposition of Electronic Communications”, filed Dec. 14, 2003; No. 60/481,899, “Systems and Method for Advanced Statistical Categorization of Electronic Communications”, filed Jan. 15, 2004), we described programmatic and objective ways of identifying bulk electronic messages, which we term Bulk Message Envelopes (BMEs). Specifically, this method can be used in email to help detect email spam.

In this filing, we extend our earlier methods and demonstrate how to correlate information in the headers and bodies of messages. An advantage is that it gives an algorithmic means of indicating which domains are associated with false sender addresses. Plus which domains appear to be acting as distributors of messages pointing to other domains.

First we define some terminology. In what follows, we consider that a mail server receives electronic messages. For brevity, we will say that the server is run by an Internet Service Provider (ISP). In practice, our method applies to any organization with a mail server that receives electronic messages. Also, we will refer to the person at that organization who uses our method as a sysadmin (systems administrator). In actuality, the person need not have a formal sysadmin position. She only needs to be authorized by the organization to perform the method described here.

Consider the important case where the electronic messages are email. Typically, the sender of an email can, if she so chooses, write false information in the header. This can include writing a false sender address or writing false relay information. Some senders do this to obscure their origins, especially if they are sending many unsolicited messages (spam). One of the simplest and earliest techniques to combat spam was when a recipient or her ISP could block future messages from a given sender address. Suppose the purported sender address was jane@one.somedomain.com. Then, the technique in its first incarnation let the recipient reject messages from jane@one.somedomain.com. But then messages from a supposed mike@one.somedomain.com would still be accepted. So the next variant let the recipient reject all messages from anyone at one.somedomain.com. The sender could then say a message was from joe@two.somedomain.com, and it would be accepted. Hence, the next step at the recipient's ISP was to let her reject all messages from any sender with a base domain of somedomain.com. The sender's countermeasure might then be to vary these base domains. In general, the sender could claim to be from any domain on the Internet. Note also that if the sender claimed a different address, there might actually be a user with this address, or not.

Various remedies have been suggested to prevent a sender writing an arbitrary address. The biggest drawbacks have been that these might involve a reworking of the standard sendmail protocol or of the underlying TCP/IP protocols of the Internet. And that a significant portion of the Internet websites would have to adopt these changes over a short time interval. An anti-network effect. Because a network effect refers to the benefits that users of a network or program derive from the fact that many other users participate. In our situation, the network refers to sendmail and the Internet, and it is a cost, not a benefit, to try to get the bulk of the users to change.

We offer a different method of tackling the false senders. It can be applied to messages that use hyperlinks. These are links in the body of a message that might use “http://” or “https://, for example. (Other protocols are possible.) In what follows, we disregard any links that are in HTML comments, because these links cannot be selected by the user (recipient). Following the steps in our earlier Provisionals, we (the ISP) find the BMEs from the incoming messages, over some period of time. This is done across all the users.

Each BME is derived from one or more messages, that canonically reduce down to that BME. For each BME, we record the base domains from links in those messages, if there are any such links. Hencefore, we shall call these base domains simply “domains”. If a BME has no domains, then our method does not apply. But this in itself is useful. Because most non-spam sent from one person to another is simply text, without any links. Whereas most spam has links. The reason is that spammers want users to easily click those links and then do some action at the linked site; most often, an impulse purchase. Plus, HTML enables the display of images that helps a spammer induce a user to click on a link.

Hence, we assume in what follows that the BMEs have links.

Each BME also records one or more of the sender addresses from the messages that it was derived from. For the sake of minimizing disk storage and memory usage, the sysadmin might choose that each BME only records up to some maximum number of sender addresses. Or she might choose that each BME record as many different ones as there are in the underlying messages.

We can then find the most frequent domains present in the BMEs, as derived from message bodies. There are various ways to find these frequencies. The simplest is to count each BME once. Another way is to weight each BME by the total number of underlying messages. We recommend this as the default weighting choice, because this total for a BME measures the incoming bandwidth and disk storage used by the underlying messages. Plus it also measures the number of messages (for that BME) that the users collectively have to deal with, if no antispam measures are taken.

Other weighting methods are also possible. In any event, the sysadmin can optionally choose a weighting method, or use a default, like the one suggested above.

Now we have a table of domains, sorted by their frequencies. From the BMEs, we can also derive other numbers to associate with a domain.

Consider a domain A. We can find the BMEs that refer to it. By this we mean those BMEs with A in their list of domains. Define a number, called “HideMe”, in [0,1], as the fraction of those BMEs that do not have A as a base domain in their sender addresses. That is, we find a numerator and a denominator. Consider a particular BME C with A in its list of domains. C has a list of senders. If A is in this list, then add the C's weight to the numerator. Else add 0. In either case, add C's weight to the denominator. (The weight is given by the choice of weighting method, as discussed above.) Do this over all of A's BMEs and then divide the numerator by the denominator to get HideMe.

We choose the term HideMe for this reason. The larger it is, the less frequently A appears in any sender address, for messages pointing to A. Imagine that “Me” refers to the domain A. The choice of Me, which usually refers to a person, is deliberate. Ultimately, each domain is owned by someone, even if we do not know who that person is. The choice of “Hide” is meant to suggest that, at least at the level of sender addresses, the larger HideMe is, the more absent A is.

We also define another number, called “HideAll”, in [0,1], as the fraction of A's BMEs where a BME's senders' base domains do not appear in the BME's body domains.

In the notation of set theory, consider a BME C, that points to A. Let S=base domains in the BME's senders. Let B=the domains in the body. If (S intersect A)=0, then we add C's weight to HideMe. If (S intersect B)=0, then we add C's weight to HideAll.

Notice that because A is in B, then S intersect B=0=>S intersect A=0. So HideAll <=HideMe. Therefore, we can also define the useful quantity Diff=HideMe−HideAll,
and Diff is in the range [0,1].

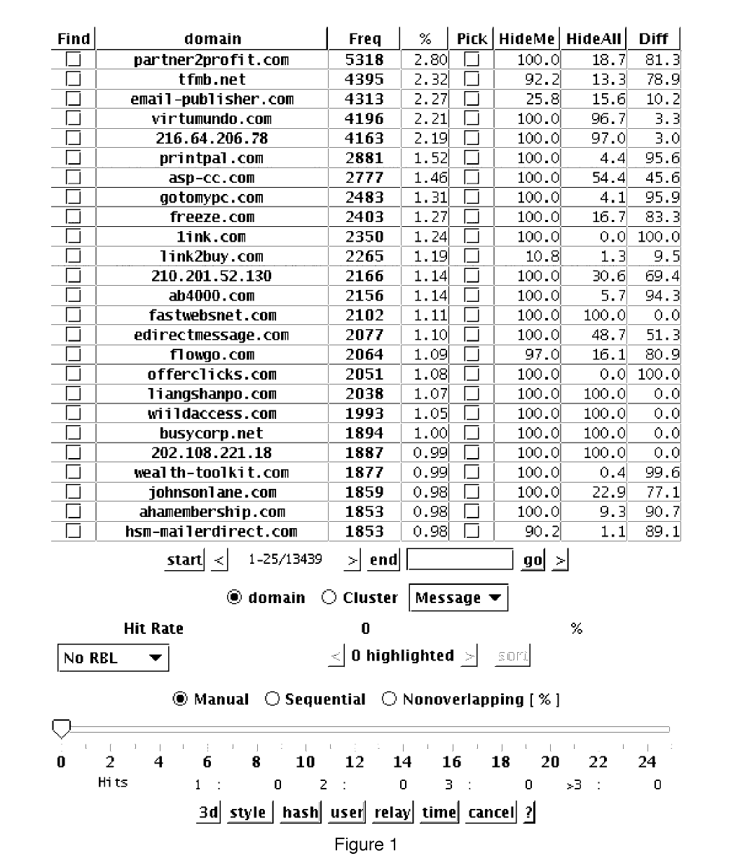

FIG. 1 shows a table derived from a corpus of email. It is for BMEs such that each BME has at least 2 underlying messages. The table was found from over 189,000 messages, reduced to 29,732 BMEs. From these, 13,439 domains were found from the bodies and are the data of the table. The table is sorted in descending frequency of the domains, where the weighting is by the number of messages in each BME. The rightmost three columns show the HideMe, HideAll and Diff values, expressed as percentages.

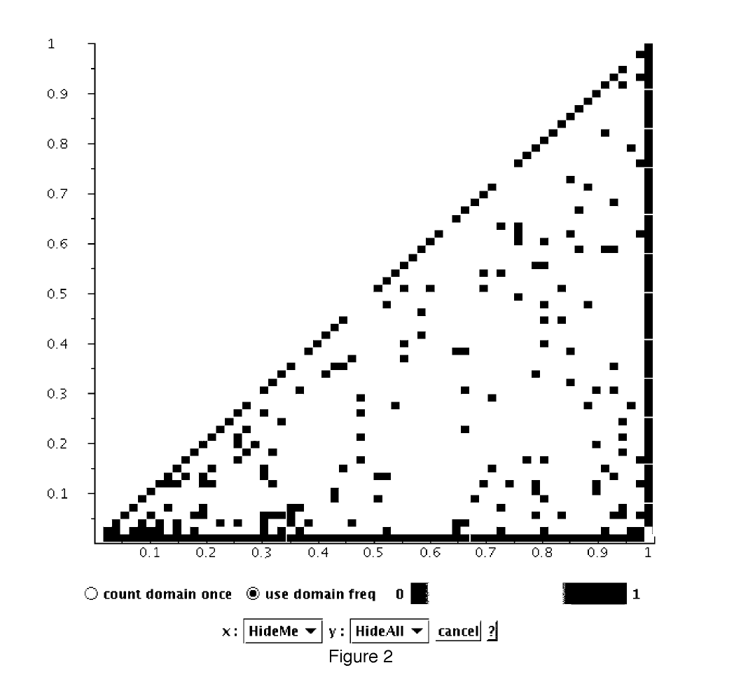

FIG. 2 then shows a graph of the domains, as a function of HideMe along the x axis, and HideAll along the y axis. In the z direction, the color coding represents the number of domains in each bin, where each domain's contribution is given by its frequency. The color coding uses the visible spectrum (red to violet), as shown in the lower right of the figure. Red means a bin with a low nonzero value. The bin with the largest value is given the most violet color. So the figure autoscales.

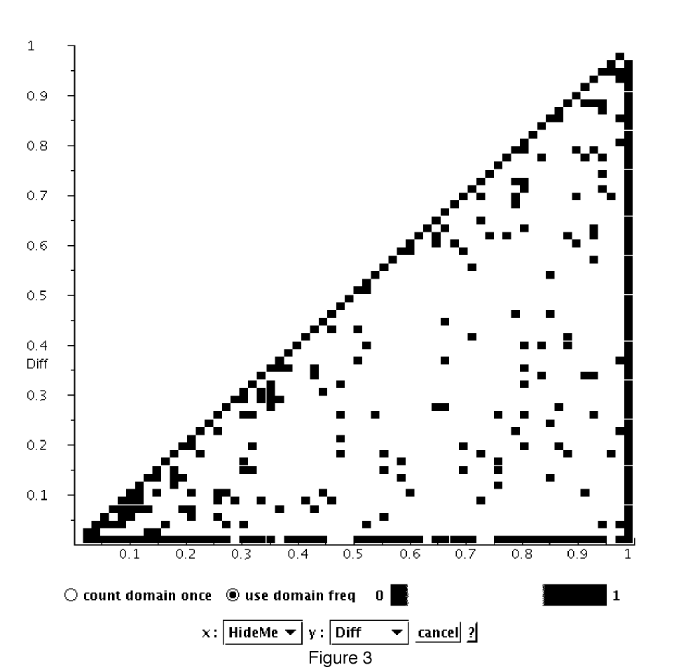

FIG. 3 shows a graph of the domains, with HideMe along the x axis and Diff along the y axis.

Clearly, we can also choose HideAll and Diff as the independent variables and obtain a similar graph. For brevity, we do not show this. It is also possible to choose as an independent variable the frequency of a domain. The resultant graphs are no longer triangular regions.

We term all such graphs, where at least one independent variable (i.e. axis) is from {HideMe, HideAll, Diff}, “Cloaking Diagrams” (CDs). They have multiple uses. The term “Cloaking” is meant to indicate that such a diagram can be used to find if a sender is falsifying (cloaking) her sender address.

Consider how FIG. 1 is a table of 13,439 domains. From necessity, only some small fraction of these can be shown at any given time. By contrast, FIG. 2 lets the sysadmin view the entire table at a glance. It summarizes in useful form properties of FIG. 1 that are not immediately obvious. Each vertex can be usefully interpreted as having a distinct meaning.

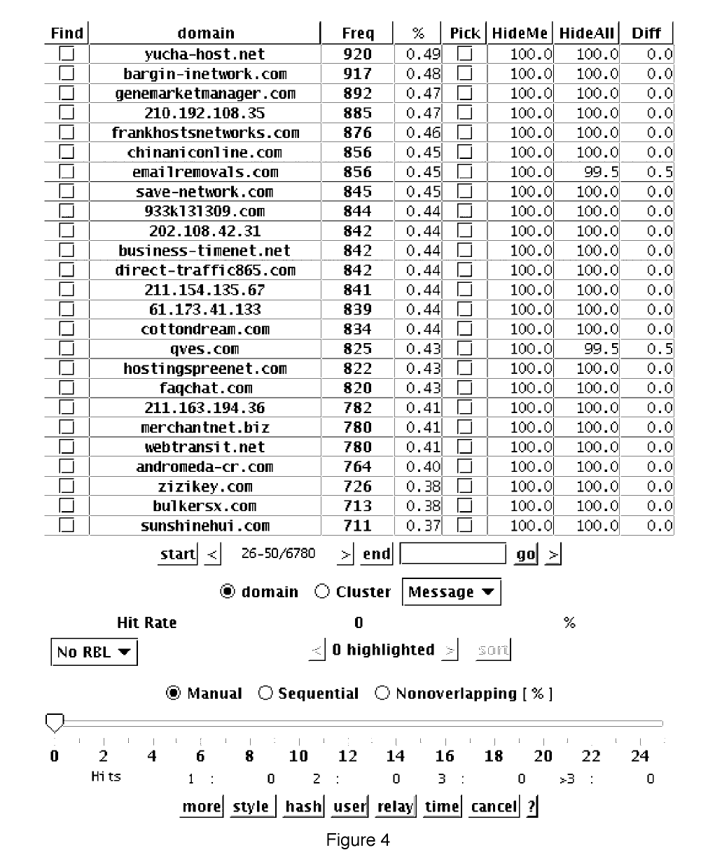

Consider the bin around the vertex (1,1). It has the 6,780 domains in FIG. 4. Approximately half of the original domains sit at this vertex. Notice in FIG. 4 how the HideMe and HideAll values are at or very near to 100%. This is true of all the values in the table, not just the small visible set in the figure. The sysadmin might choose to regard these domains as potentially having false addresses, given that very few, if any, of the domains in the messages appear in the senders for those messages.

Strictly speaking, our method does not prove that these domains use false senders. But notice that FIG. 4 is sorted by descending frequency count. The sysadmin could decide that the greater the number of messages associated with such a domain, the greater the probability that the domain is using false senders. She could choose some cutoff point in frequency, and then regard domains with greater frequencies as spammer domains. Then, she could mark current and future messages, with body domains in this list of spammer domains, as potential spam, and, for example, put them in a bulk folder for each recipient.

Many other methods can be built on top of our CDs. For example, the sysadmin might want to take the BMEs referred to in FIG. 4, and run further tests, to ascertain if they are to be considered as spam. These might include language dependent syntactic or semantic tests. A specific example might involve training a Bayesian on such BMEs. A common problem with Bayesians as they are currently used is having to frequently retrain them. Because spammers attempt to poison them with random words. One problem that arises with retraining is how to periodically find a set of spam and a set of non-spam to train upon. Our method gives an algorithmic way to do so. BMEs from the (1,1) neighborhood can be considered to be spam, or filtered via other algorithmic steps to get spam.

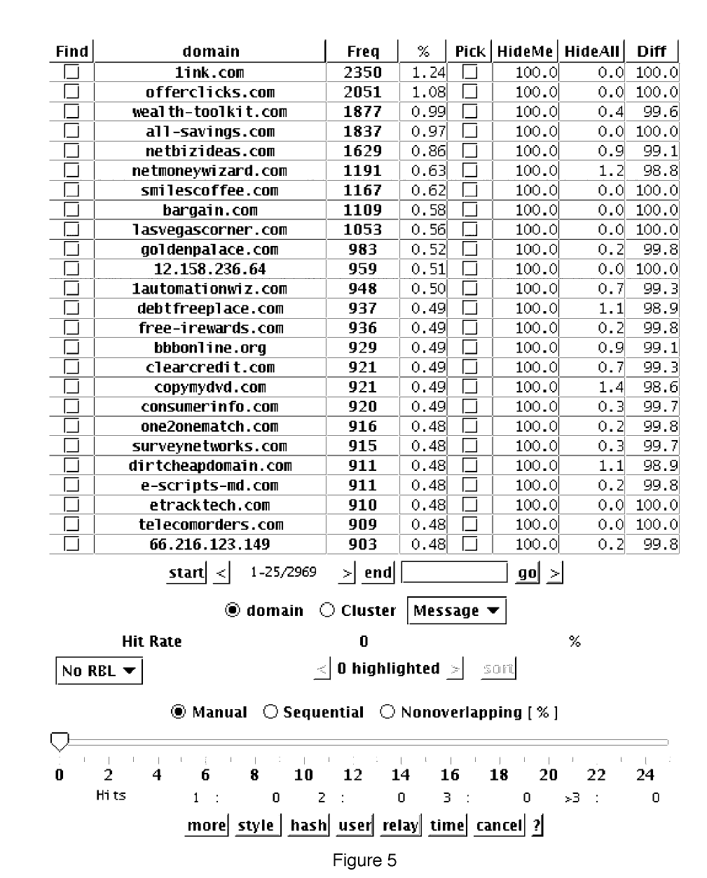

Now consider the bin around the vertex (1,0) in FIG. 2. Its domains are shown in FIG. 5. There are 2,969 domains. The HideMe values are at or near 100% and the HideAll values are at or near 0%. And this is true of the entire table, not just the values shown in FIG. 5. A sysadmin could regard these domains are distributors. That is, the domains do not seem to reveal themselves in the sender lines. But each message's sender domain appears in a link in the body, back to that domain. The distributors seem to be keeping a low profile, vis-a-vis the sender lines. But they are possibly acting on behalf of other domains, who do not mind being in the sender lines. Alternatively, a message does come from the actual sender domain, and that domain has some arrangement with the domain near (1,0), to furnish a link to the latter in the message.

For a given domain, our method cannot distinguish between these two hypotheses. But the sysadmin may regard that as irrelevant. The key point is that there is a qualitative difference between the domains at (1,0) and those at (1,1). At (1,0), we have higher confidence that the sender domains are valid. Both types of domains are involved with bulk mail. But the (1,0) domains are more likely to be newsletters or non-fraudulent bulk mail. The sysadmin may still choose to regard the (1,0) domains and messages as spam. Or, perhaps, she can put different downstream processing steps for (1,0), compared to (1,1).

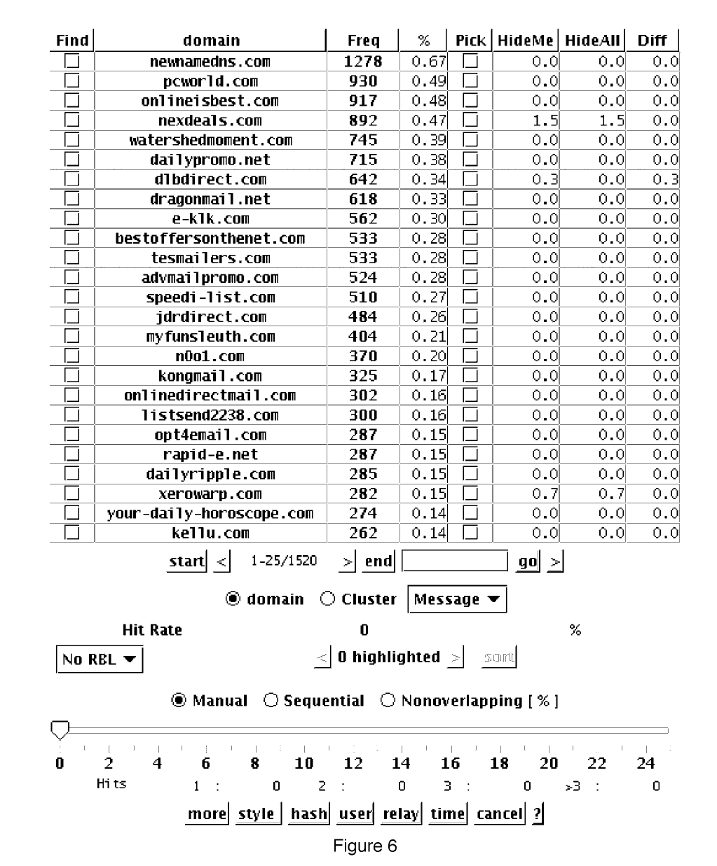

Now consider the bin around the vertex (0,0) in FIG. 2. Its domains are shown in FIG. 6. There are 1,520 domains. The HideMe values are at or near 0, and likewise with the HideAll values. This is true of the entire table, not just the values shown in FIG. 6. Essentially, most associated messages may be considered to have valid sender addresses. The sysadmin may then treat these differently from those at the other vertices.

Another possibility is that the sysadmin treats the domains and messages associated with the line HideAll=0 in the same fashion as described above for (1,0). Namely that these are more likely to be newsletters or non-fraudulent bulk mail, compared to the (1,1) region.

From the above discussion, we see that vertices and edges can be considered to have different meaning, with different consequences for later processing.

A minor variation on the above discussion is to permit the sysadmin to set a neighborhood radius or boundary around each vertex or edge, so as to include all bins fully contained, or perhaps partially contained in that neighborhood.

Another minor variation is to omit the use of the bins, which was a computational convenience. Instead, points are drawn for each domain.

Note in the above example that from the bins around the 3 vertices, we have a total of 11,269 domains, out of 13,448 domains. That is, some 84% of the domains fall at the vertices. Obviously, other data sets would yield different numbers. But the example we have shown here demonstrates the usefulness of having an algorithmic, language-independent means of autoclassifying domains (and their associated messages).

We can also use an exclusion list of known good domains, to prevent a misclassification of a domain as a spammer domain. For example, if a spammer is aware of our method, she might send messages, each with several links. Some of these might be to unrelated/unaffiliated large companies, or governments or educational institutions. The sender lines might be not be to any of these links. So she wants us to misclassify those unrelated domains as spammers. Hence, we can use an exclusion list, that includes, for example, *.edu, *.org, *.mil, as well as, say, a list of large companies that we are willing to consider as not being spammers.

More generally, let us consider what else a spammer might do, if she is aware of our method, and wishes to circumvent it. She can of course, omit links altogether. While it defeats our method, it also lowers her response rate, as discussed earlier, because there is no longer a clickthrough. So assume that she retains links to her domain. She might then try to introduce enough random characters or random words so that our BMEs derived from her messages are degenerate. That is, each BME is made from only one message, due to the variability she introduced. This itself comes at a cost to her. The noise in her messages lowers their visual appeal and can be expected to thus lower the clickthrough rate. But even when our BMEs are degenerate, we can still find all the BMEs pointing to a given domain. Here, each BME only has one sender. The HideMe and HideAll can be found for the domain. Suppose before she made her countermeasures, her domain had HideMe=HideAll=1. If, after her changes, she still has false senders, we can still find HideMe=HideAll=1.

Of course, increasing the number of messages avails her no good. Unlike a Bayesian method, say, our method deterministically finds all finds all messages pointing to a domain. And if her messages increase, it makes the domain more prominent and hence more likely that we apply other analysis to it, based on its prominence.

It should also be seen from the above case of degenerate BMEs that our CD method can be applied even if we do not compute BMEs. That is, we deal with individual messages, from which we extract one sender domain per message, and link domains (if any) from the body of each message. This bypasses the canonical steps and hashing described in our earlier applications. But the method of this application can still be applied.

A subtler approach by her might be to move her location on the CD away from (1,1) in FIG. 2. We have assumed that she knows of our method. Also, she might guess that our autoclassification might be confined to a small region around (1,1). If so, she might try to move her domain outside that region. But she is confined to the triangle in FIG. 2. In response, we might have steps to check the nonempty bins throughout the interior. If a domain appears in a bin, and the domain has some frequency above some preset amount, say, then we could direct further analysis towards it.

Plus, any time that she moves away from HideMe=1, she faces a simple and ironic risk. When HideMe<1, it means that her domain has some fraction of messages with the sender domain equal to it. These can be trivially blocked by a simple antispam technique, as mentioned at the start of this filing. In general, she cannot be sure that we are not also using this, in conjunction with our method and possibly other methods.

Our discussion above has shown the usefulness of the HideMe and HideAll, and how to combine these in the graphical form of a CD, and how to then use the CD to classify domains. The

CD is useful for manual analysis by the sysadmin. Clearly, it is possible to bypass the CD and write a program with rules that amount to computing HideMe and HideAll for a set of domains, and then apply downstream steps, based on these values, in a fashion equivalent to drawing the CD and proceeding from there. We claim this and all other usages of HideMe and HideAll, jointly or separately.

Extensions include, but are not limited to, the following items:

There is other domain information in the header. Namely the purported relays and the purported times that a message passed through a relay. These could be analyzed in conjunction with the above method, and possibly with the last IP address of a known valid relay, to find an indicator that a relay is false, or that a sender is false. To this ends, domain chains found from traceback/traceroute analysis could also be used as an extra information source.

The CD can also be used to study the time dependent behavior of a set of messages or domains. For example, the messages could be divided into those received in various non-overlapping time intervals. Then for each time interval, the domains and CD can be derived. We can then study any movement (trajectories) of the domains on a CD, across the time intervals. We can study the behavior of individual domains, or of an arbitrary subset of domains.

A BME also stores the first and last times at the ISP that its messages were received. These times are not written by the senders. These times, or their difference, could also be used in conjunction with this method, for an extra indicator about a domain, its BMEs or its messages.

Our method is not restricted to email or HTML. It can be applied to any electronic communication where a sender address can be insecure and where links are present inside messages, that point to destinations in that electronic network, or to destinations in other electronic communications modalities.

For a group of domains, computing HideMe and HideAll for the entire cluster. Then using HideMe and HideAll in the fashion described above, to classify the group.

The group of domains in the previous item might be found by the clustering methods of our Provisional No. 60/481,745.

The group of domains might be those within a given address range, like perhaps that of a particular ISP or NSP

We now describe another, complementary means of graphical analysis, to be applied against spam.

We assume for brevity that incoming messages are received by an Internet Service Provider (ISP). In general, our statements apply to any organization that runs a message server for its members. Also, when we say “user” below, we mean the recipient of a message.

We (the ISP) choose a subset of our users. (Later we explain how this choice might be made.) For these chosen users, we take messages received by them in some common time interval. Given these messages, we analyze them by our canonical steps in Provisionals #0046, #1745, #1789, #1899, and Provisionals No. 60/521,014 “Systems and Method for the Correlation of Electronic Communications”, filed Feb. 5, 2004, and Provisional Patent No. 60/521,174, “System and Method for Finding and Using Styles in Electronic Communications”, filed Mar. 3, 2004, to build Bulk Message Envelopes (BMEs). These contain various types of metadata, including domains, hashes, styles, users and relays.

Pick a given metadata type. We take the BMEs that are each derived from more than one message. (We term these BMEs “Multiples”). Find the different values for this metadata type. For each value, we associate a number (“count”) that measures, in some sense, how often that value occurs in the BMEs. These measures include, but are not limited to, the following:

If a value occurs in a BME, add 1 to the count.

If a value occurs in the BME, add to the count the number of messages in the BME.

Hence we can sort the values according to their counts. If several values have the same count, then we can choose some secondary ordering to sort these values. Like lexicographic, for example.

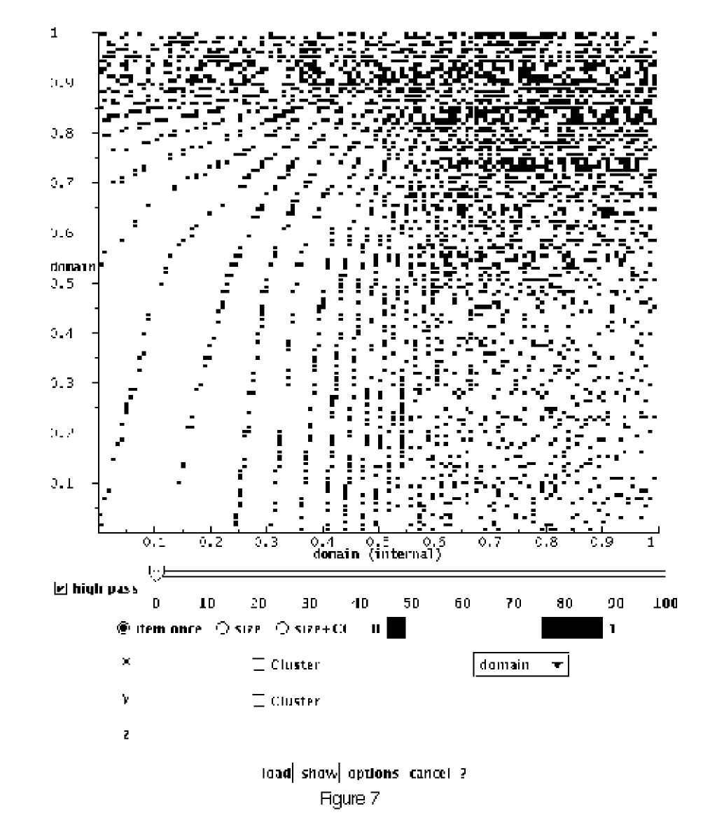

Do likewise for BMEs that are each derived from only one message. (We term these BMEs “Singles”.) We now have two ordered sets of values. Use these as x and y values. We give an example in FIG. 7. Here we are looking at domains. The x axis is for domains found from Multiples, and the y axis is for domains found from Singles. The values are normalized to [0,1] in each direction, for convenience, where the largest domain in each direction is given the coordinate 1. Suppose we have a given domain, alpha. It contributes to the graph only if it appears in both axes. Clearly, in this case, its x and y coordinates will be different, in general. We go to the bin for alpha's (x,y) and add a contribution to the bin based on it containing alpha. This contribution could be based on several methods, including but not limited to the following:

Just add 1.

Use alpha's count, as given above.

Do this for all domains that appear on both axes.

The bins are color-coded in some fashion, to show their values. We choose the visible spectrum as the color coding mapping, though this is purely a matter of convenience. The lowest values in the bins are red, and the highest values are violet. This normalizes the display in the z direction.

Of course, we could alternatively use a general purpose three dimensional graphing package to represent the data.

FIG. 7 shows clearly discernible curves. These indicate an underlying association between the data (domains in this case) on each curve. The ISP can choose to classify or categorize the data on a curve into one group. For example, suppose the ISP finds, by whatever means, that several domains on a curve are spammer domains. Then the ISP might choose to regard the rest of the curve as being spammers. One practical consequence might be add these domains onto the ISP's blacklist. This follows the spirit of our #1745, where we find clusters, and then let the ISP choose to block all the domains in a cluster of domains, if several of these domains are judged to be spammers.

Note that we do not claim that curves will be discernible in every instance. But where they can be, the ISP can take advantage of this.

Our method can be used when the curves' members are found manually or algorithmically.

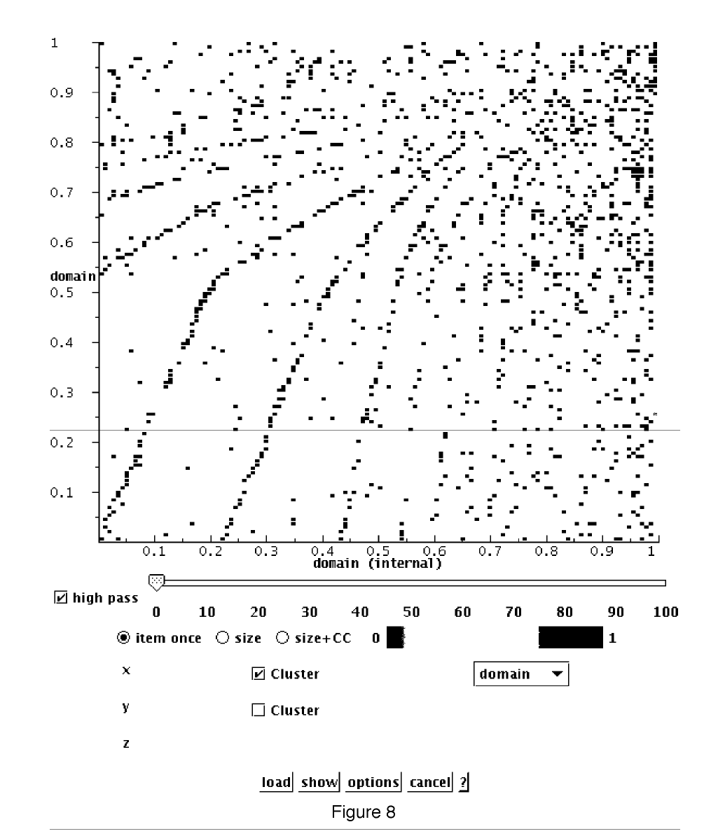

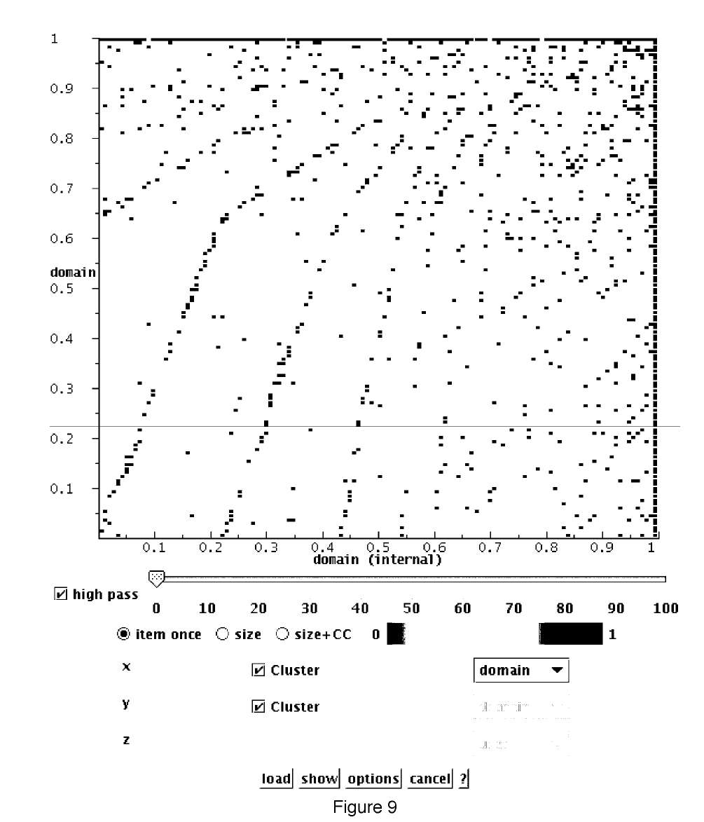

Our method complements the cluster finding of Provisional No. 1745. For example, FIG. 8 is derived from FIG. 7, where now clusters have been found in the x direction, and most of the data has been pushed into the largest clusters near x=1. Curves are still clearly visible. FIG. 9 is derived from FIG. 8, where now clusters are also found in the y direction. Again, curves are still visible. These curves mostly constitute clusters that are small in two senses. They have few members (domains). Often just one. And the count for each member is small.

This gives the ISP an ability to expand the scope of #1745, which is efficient in classifying or categorizing a large cluster. But when you construct clusters, you might find a long tail end of small clusters. And #1745 does not describe how to associate different clusters. Clusters are disjoint, by explicit construction. Therefore, here we have an efficient means of grouping across clusters.

The combination of cluster analysis and the graphical analysis presented here is useful. They offer alternate views into the data. The cluster analysis is a topological analysis of the interconnections in the metadata. While the graphical analysis offers a metric space (Euclidean) view of the frequencies of occurrence of the metadata.

In some instances, a large cluster may span several curves. Hence, it is sometimes possible to correlate different parts of a cluster with different curves. Thus, we can apply different categorizations to different parts of a cluster.

Along the lines of a large cluster spanning several curves, it is sometimes possible to see this, with the additional effect of “banding”. Imagine that we make this cluster from data in the x direction, say. Banding is where a portion of the cluster maps to different curves, but the projections of the portion onto the x axis yields distinct groupings or bands. Various metrics may be defined to characterize the portions of the cluster that exhibit this behavior.

By selecting metadata in a curve, and comparing these across different curves, we can search for any correlations. Including in the time domain. This might involve the times when the underlying messages were received by the ISP. Or the purported times for the relays in the message headers. These latter times are purported, because spammers could have forged some of them. But we can look for any anomalies in the relay times, to help search for forged times.

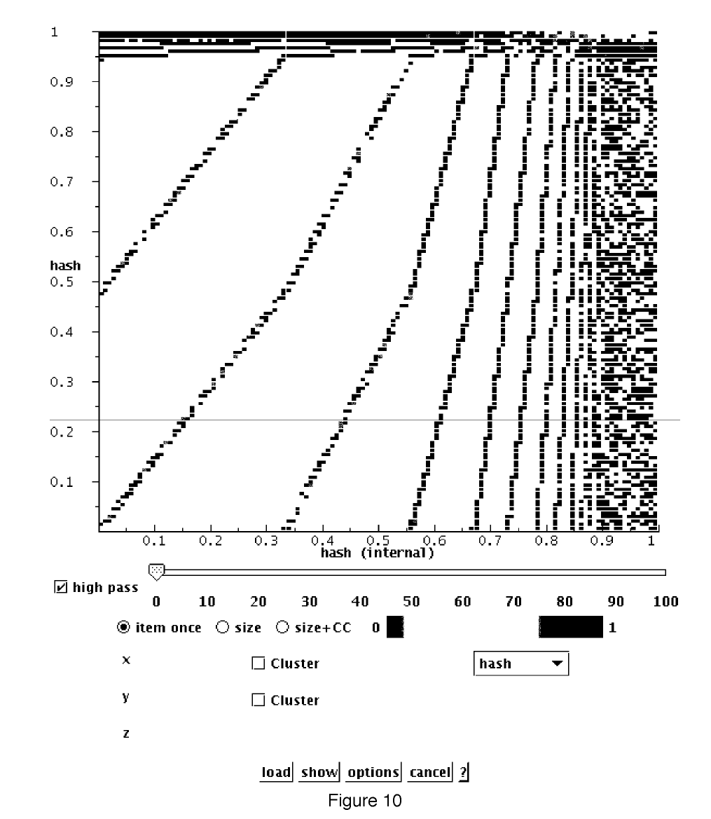

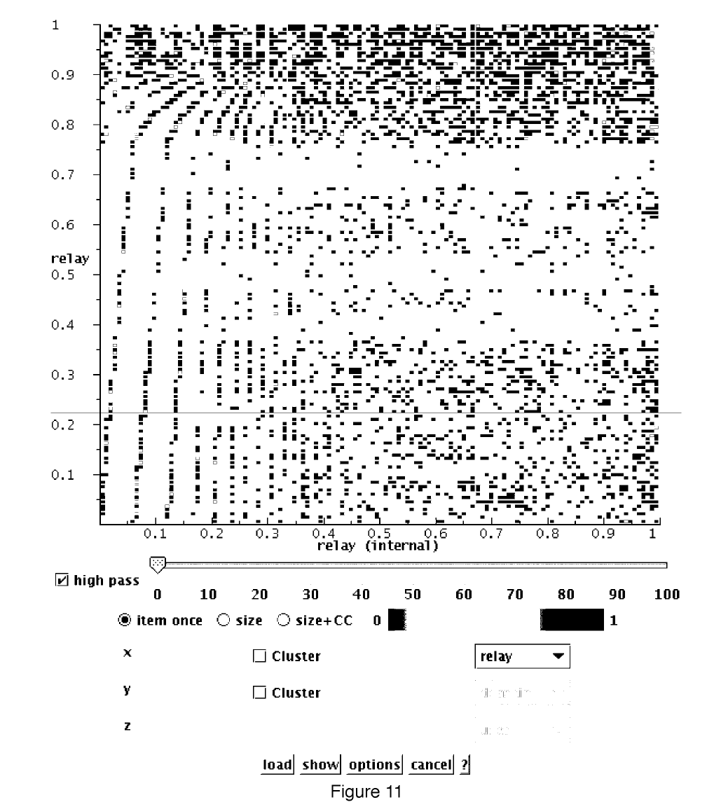

We can also see curves in other metadata spaces. FIG. 10 shows this for hashes. And FIG. 11 shows this for relays.

These are several possible causes of domains, including but not limited to those discussed below.

Consider FIG. 7, for curves of domains. Two domains close to each other on the same curve have the property that in each set of messages, the domains appeared with similar frequencies. This could be coincidence in one set. But for it also to be coincidence in the other set is less likely, in general. Plus, it is even less likely when more points can be discerned on a curve, and the curve has a clear spatial separation from other points or curves.

We suggest that a possible cause for a curve is that the domains on it are mostly using a common mailing list. If so, our method has extra utility. Spammers tend to specialize in different tasks. Some spammers harvest and sell mailing lists to other spammers. By considering all the domains on a curve as spammers, and blocking them, we reduce the economics of selling mailing lists.

How might the spammers respond? One possible way is to consider a spammer with a given domain. She buys a mailing list. But if she uses all of it, she runs the risk that she will end up on the same curve as other spammers, even if she does not know who these others are. Because she has to expect that whoever she bought the list from will also sell it to others. And if she ends up on a curve with a given ISP, it might block her future messages. So she might resort to sending each particular message to random subsets of her list. This reduces her income, because of the low response rate to spam, and hence, ultimately, the value of the list to her.

It might be objected that for domains of low frequencies on a curve, this is moot, because those domains are sending us few messages anyway. But there is always the possibility that a current low frequency domain might ramp up and send us far more messages in future. So there is merit in blocking these domains.

Consider FIG. 10, for hashes. One possibility for the curves is the presence of templates. That is, a group of spammers might use a common message body, with appropriate links to each spammer's domain. Or, they might also make it from a set of common phrases that we end up hashing. In any event, we can do several things. We can record the hashes along a curve. So that in future messages, when we do our canonical steps and hashing, if we see some minimum number of these hashes in a new message's hashes, we might regard the message as spam.

We can also find the domains corresponding to the hash curves, and possibly treat these as spam. Sometimes, this may be redundant, if our other analysis has already marked these domains as spam. But that is actually useful, for it gives us an extra way to analyze a domain.

Consider FIG. 11, for relays. Remember that a spammer might forge many parts of a header. An ongoing problem has been the existence of open relays, because spammers can send their messages through these. The existence of relay curves gives us several possibilities. One is to take relays on a curve, map back to the associated messages and domains. Then see if any of these domains are considered spam domains. If so, then we might mark the other associated metadata on the relay curve as spam-related. Also, we can analyze the headers for these messages, and try to discern the most common nearest open relays to us (the ISP). While spammers can indeed forge header information, typically, once they send a message to an open relay, all subsequent additions to the header are valid.

Knowing these open relays lets us inform their system administrators. Or we can block future messages from these relays.

Our method above can be generalized in various ways, including but not limited to the following.

The ISP can choose two nonoverlapping subsets of users, make a separate set of BMEs from each user subset, and then compare the results, using the above method, to see if any such curves/correlations exist. Obviously, for greater validation, the ISP might choose to make several nonoverlapping subsets of users, and look for the existence of “characteristic curves” across multiple graphs. A utility is that the ISP does not have to run the above method on all of its users (which might be a heavy computational burden).

In doing the previous item, the ISP might compare the Singles from one set against the Singles or Multiples in the other set. Or compare the Multiples. Or, the ISP might compare the entire data in a set against the entire data in the second set, or against only the Singles or Multiples in the second set.

If the ISP has users spread over a wide area, and it can associate a user with a region, then it might choose to make one subset from users in one region and another subset from users in another region. Then the above method might yield information about bulk senders that are targeting its users in a non-geographic specific sense. Conversely, it could find results from comparing sets of users derived from one region, and results from comparing sets of users in another region. Then it could compare both sets of results to find bulk senders (and related data) targeting its users in a geographic specific sense.

Clearly, if the ISP has other information on its users, it might apply the method of the previous item, based on this other data. For example, if it knows the users' occupations or hobbies, then it might group subsets of users based on this.

The ISP can exchange data with another ISP (or organization), in a peering arrangement, so that both ISPs could improve the efficacies of their efforts. This takes advantage of the fact that spammers need to send to as many addresses as possible, to maximize their responses, and so spammers often target multiple ISPs and organizations.

When two sets of BMEs are compared by the above method, the time period over which the original messages were accrued was described as being the same. But this is not necessary, though it is preferred. It is possible to have the two sets of messages being gathered over different time intervals. We have seen in our tests that even entirely nonoverlapping time intervals can give positive results. Furthermore, the two sets of messages can be intra-ISP or inter-ISP. In the latter case, we have also seen positive results. We suggest that this is because some spammer domains remain active for extended periods.

When comparing two sets of BMEs, whether intra-ISP or inter-ISP, a question arises as to whether the sizes of the two sets should be similar. Consider this at the user level. Two users will get different amounts of messages in the same time period, in general. But if you choose enough users, then this can be averaged away. So a preferred implementation is that the two sets of BMEs should be derived from two nonoverlapping sets of users, with approximately the same number of users in each set, where you might take “approximately” to mean the same order of magnitude. But this “restriction” can be relaxed. From our tests, we have successfully compared a set of 600 users from one ISP with another set of 10 users, where the latter are distributed across other ISPs. Under this extreme case of a small 10 user set (and also nonoverlapping in time with the other set), we can still get positive results.

Items 5 and 7 have the following implication. A company may not have enough users to successfully use our methods strictly on its own user base. Or the application of our methods may block some spam but let through other spam. An ISP could then offer the company the ISP's BMEs (or results thereof). Optionally, the ISP may get the company's BMEs (or results thereof). The point here is that the company can then use the much larger data set from the ISP to compare against its own messages. From item 5, we recommend that the company have at least 10 users.

Our methods can also be applied, though possibly with lower efficacy, in this fashion. Given two sets of messages, we just extract domains from selectable links in the bodies. Taking care to avoid HTML comments. (Also, if we encounter dynamic hyperlinks, we might choose to evaluate these according to our Provisional No. 60/521,698, “System and Method Relating to Dynamically Constructed Addresses in Electronic Messages”.) In each set, we tally up the domains, sorted according to their frequencies of occurrence. So this avoids the construction of BMEs. We might also remove domains from either set that are in an exclude list of domains. We then graph these two domain lists against each other, and look, either manually or algorithmically, for the existence of curves. If these are determined to exist, then we might classify the domains in a given curve into one group, and optionally apply some action to the entire group, or to messages pointing to any members of that group.

In other Electronic Communication Modality (ECM) spaces (like Instant Messaging), our methods can also be applied. As shown in our earlier Provisionals, from messages in those spaces, metadata can be extracted and BMEs built. Accordingly, we can apply the steps given here to such data.

Also, our methods can be applied across different ECM spaces. For example, domain metadata extracted from a corpus of email might be compared to domain metadata extracted from a corpus of Instant Messages.

What is claimed is:

1. A method, for a domain Alpha, of defining HideMe as the fraction of Bulk Message Envelopes (BMEs) which do not have Alpha as a domain in their sender addresses, out of all the BMEs which have Alpha as one of their body link domains.

2. The method of claim 1, where the weighting of the BMEs used in computing the fraction is given by the number of messages in each BME.

3. The method of claim 1, where the weighting of the BMEs used in computing the fraction is one (1) for each BME.

4. The method of claim 1, where the weighting of the BMEs used in computing the fraction is the number of different users (recipients) in each BME.

5. A method, for a domain Alpha, of defining HideAll as the fraction of Alpha's BMEs where the BME's senders' base domains do not appear in the BME's body domains, out of all the BMEs which have Alpha as one of their body link domains.

6. The method of claim 5, where the weighting of the BMEs used in computing the fraction is given by the number of messages in each BME.

7. The method of claim 5, where the weighting of the BMEs used in computing the fraction is one (1) for each BME.

8. The method of claim 5, where the weighting of the BMEs used in computing the fraction is the number of different users (recipients) in each BME.

9. The method, for a domain Alpha, of characterizing it with a HideMe and HideAll, as found from a set of BMEs, using the methods of claims 1-8.

10. The method for a set of domains found from a set of BMEs, of finding their (HideMe, HideAll) values, using claim 9, and then graphing this using HideMe and HideAll as the coordinate axes. (A “Cloaking Diagram”).

11. A method of taking BMEs associated with one set of users, sorting the base domains in any links in the BMEs by the weights of the BMEs, doing likewise with domains from BMEs from a different set of users, and comparing the two sets of sorted domains, to aid in the classification or categorization of some or all of these domains.

12. The method of claim 11, except that the BMEs are associated with the same set of users, and one set of BMEs has each BME made from more than one message, and the other set of BMEs has each BME made from only one message.

13. The method of claim 11, where the clusters are found from the domains, and the two sets of clusters are compared, to aid in the classification or categorization of some or all of these clusters and their contained domains.
